(19) United States
(12) Patent Application Publication
(10) Pub. No.: US 2025/0263953 A1
(43) Pub. Date: Aug. 21, 2025

(54) ENERGY HARVESTING DOOR LOCK

(71) Applicant: ASSA ABLOY Access and Egress Hardware Group, Inc., New Haven, CT (US)

(72) Inventor: Michael Bedford, East Hampton, CT (US)

(73) Assignee: ASSA ABLOY Access and Egress Hardware Group, Inc., New Haven, CT (US)

(21) Appl. No.: 19/051,577

(22) Filed: Feb. 12, 2025

Related U.S. Application Data
(60) Provisional application No. 63/555,509, filed on Feb. 20, 2024.

(51) Int. Cl. E05B 47/00; H02K 7/116; H02K 7/18; H02K 11/00

(52) U.S. Cl. CPC E05B 47/0001; H02K 7/116; H02K 7/1853; H02K 11/0094; E05B 2047/0022; E05B 2047/0058; E05B 2047/0062

(57) ABSTRACT

An energy harvesting device for a door lock assembly may include a gearbox assembly having a gear train with a plurality of gears operatively coupled to one another. The plurality of gears may be operatively coupled to a door handle of the door lock assembly such that actuation of the door handle actuates the plurality of gears. The energy harvesting device may also include a generator operatively coupled to the gear train, and the generator may be configured to convert mechanical energy provided from the gear train when the plurality of gears are actuated to electrical energy. The energy harvesting device may also include an energy storage device configured to store the electrical energy converted by the generator such that the stored energy can be expended for actuation of the door lock assembly, among others, at a later time.

This application claims priority under 35 U.S.C. § 119(e) to U.S. Provisional Application No. 63/555,509, filed Feb. 20, 2024, the content of which is incorporated by reference in its entirety for all purposes.

### FIELD

Disclosed embodiments are related to energy harvesting devices for a door lock assembly and associated methods of use.

### BACKGROUND

Conventional bored lock mechanisms may be configured as electronic locks which are powered by using finite electrical power sources such as batteries. These power sources may supply power to operate the lock mechanism between a locked state and an unlocked state as desired. In some instances, the electronic locks may be operated wirelessly such as by Bluetooth®, WiFi or other near field communication (NFC) to remotely communicate with the lock mechanism.

### SUMMARY

According to one embodiment, an energy harvesting device for a door lock assembly may include a gear train comprising a plurality of gears operatively coupled to one another. The gear train may be operatively coupled to a door handle of the door lock assembly such that an actuation of the door handle actuates the plurality of gears. In some embodiments, a gear ratio of the gear train is greater than or equal to 30:1. In some embodiments, the energy harvesting device may include a generator operatively coupled to the gear train, where the generator is configured to convert mechanical energy provided from the gear train when the plurality of gears are actuated to electrical energy. The energy harvesting device may also include an energy storage device, and the energy storage device may store the electrical energy converted by the generator.

According to another embodiment, an energy harvesting device for a door lock assembly may include a gear train comprising a plurality of gears operatively coupled to one another, where the gear train is a planetary gear train including one or more planetary gears and one or more sun gears. The gear train may be operatively coupled to a door handle of the door lock assembly such that actuation of the door handle actuates the plurality of gears. In some embodiments, the energy harvesting device may include a generator operatively coupled to the gear train, where the generator is configured to convert mechanical energy provided from the gear train when the plurality of gears are actuated to electrical energy. The energy harvesting device may also include an energy storage device, and the energy storage device may store the electrical energy converted by the generator.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective exploded view of a door lock assembly, according to some embodiments;

FIG. 2A is a perspective view of gearbox assembly configured for use with a door lock assembly, according to some embodiments;

FIG. 2B is a perspective exploded view of the gearbox assembly of FIG. 2A, according to some embodiments;

FIG. 2C is a perspective exploded view of the gearbox assembly of FIG. 2A, according to some embodiments;

FIG. 2D is a perspective exploded view of region 2D of the gearbox assembly of FIG. 2C;

FIG. 3A is a front perspective view of a gearbox assembly configured for use with a door lock assembly, according to some embodiments;

FIG. 3B is a rear perspective view of the gearbox assembly of FIG. 3A; and

FIG. 3C is a perspective exploded view of the gearbox assembly of FIG. 3A.

### DETAILED DESCRIPTION

Bored locks are commonly found throughout commercial, residential, and industrial buildings, and may be installed by boring two holes perpendicular to one another into the door. These holes may include a “face bore” which is bored into the face of the door and an “edge bore” which is bored into the edge of the door. The face bore may receive the components of the bored lock mechanism and a latch bolt of the mechanism may be extended and retraced through the edge bore to be engaged and disengaged, respectively, with a corresponding door jamb to lock and unlock the door. These bored locks may be configured as electronic locks that operate via electrical energy supplied from finite power sources (e.g., batteries, etc.). In cases where such finite power sources are used to power the electronic lock systems, the batteries will require routine recharging/replacement and maintenance to maintain functionality of the lock mechanism.

In view of the above, the inventors have recognized benefits associated with an energy harvesting device that may be configured for use in an electronic door lock assembly (e.g., a bored lock mechanism) to extend the operational life span of the door lock. In particular, energy harvesting devices according to the embodiments disclosed herein may serve to harvest mechanical energy from the actuation of the door lock, and then convert the mechanical energy into electrical energy which is then stored in an energy storage device. The stored electrical energy may then be expended from the energy storage device to assist in operating the lock mechanism between locked and unlocked states, thereby reducing the energy required to be expended from the power source to operate the lock which extends the life span of the door lock assembly. Such energy harvesting devices may be retrofitted into existing lock mechanisms such as bored locks as primarily described herein, though the use of energy harvesting devices in other lock mechanisms are contemplated (e.g., mortise locks, etc.).

In some embodiments, the inventors have recognized particular benefits to an energy harvesting device which may employ gearing systems to achieve a high rate of energy conversion of the mechanical energy from the actuation of the door lock to the electrical energy stored in the energy storage device. That is, the inventors have found that a gear train which is operatively coupled to a door handle of the door lock assembly may increase the efficiency of energy conversion and thus increase the amount of energy which is available to be stored. In some embodiments, the mechanical energy from the gear train may be converted to electrical energy via a generator which is operatively coupled to the gear train. The converted electrical energy may then be stored in an energy storage device (e.g., a capacitor, rechargeable batteries, etc.). The stored electrical energy may then be expended as needed to actuate the door lock between locked and unlocked states, thereby extending the operational lifespan of the door lock assembly and reducing the frequency at which the power source (e.g., batteries) needs to be replaced. The inventors have also recognized that the gear ratio of the gear train may be selectively increased to provide a greater rate of energy conversion from the actuation of the door lock.

In some embodiments, a gearing system may be of any suitable type including, but not limited to planetary gear trains, compound spur gear trains, rack and pinion gear trains, reverted gear trains, worm gearing, bevel gearing, or any other suitable type as the disclosure is not so limited. The gear ratio of the gearing system may be selectively chosen to provide a desired amount of mechanical energy conversion to the generator. In some embodiments, the gear ratio of the gearing system may be greater than or equal to 4:1, 6:1, 10:1, 20:1, 30:1, 40:1, 50:1, 60:1, 70:1, 80:1, 90:1, 100:1, 110:1, 120:1, 140:1, 160:1, 180:1, 200:1, or greater. Accordingly, the gearing may have any suitable number of gear teeth as necessary to achieve a desired gear ratio while maintaining a compact gear design. For example, a planetary gear may have a number of gear teeth greater than or equal to 10, 20, 30, 40, 50, 60, 70, 80, or more gear teeth while a sun gear may have a number of gear teeth greater than or equal to 10, 12, 14, 16, 18, 20, 22, 24, 26, 28, 30 or more gear teeth.

In some embodiments, the generator may of any suitable type including, but not limited to motors such as direct current (DC) motors, brushless DC motors, or any other suitable generator type as the disclosure is not so limited. As disclosed herein, the generator may be operatively coupled to the output of the gear train such that mechanical energy from actuation of the door handle of the door lock assembly and the gear train may be converted to electrical energy via the generator which is then stored in the energy storage device.

In some embodiments, the energy storage device may be of any suitable type including, but not limited to capacitors (e.g., supercapacitors, electrolytic capacitors, ceramic capacitors, etc.) and rechargeable batteries (e.g., lead-acid batteries, nickel-cadmium batteries, nickel-metal hydride batteries, lithium-ion batteries, lithium-ion polymer batteries, alkaline batteries, etc.).

In some embodiments, a controller and/or one or more processors may be included within the door lock assembly, and the controller may be configured to control the operation of the door lock between locked and unlocked states using at least in part the energy stored in the energy storage device. Further, though one use of the generated and stored energy is for lock operation, it should be appreciated that the current disclosure is not so limited and other uses for the energy are contemplated, such as for monitoring the status of the lock and/or the associated door, provided illumination, providing an indication as to the status of the lock and/or door, and transmitting and receiving signals between the lock and a gateway, to name a few.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

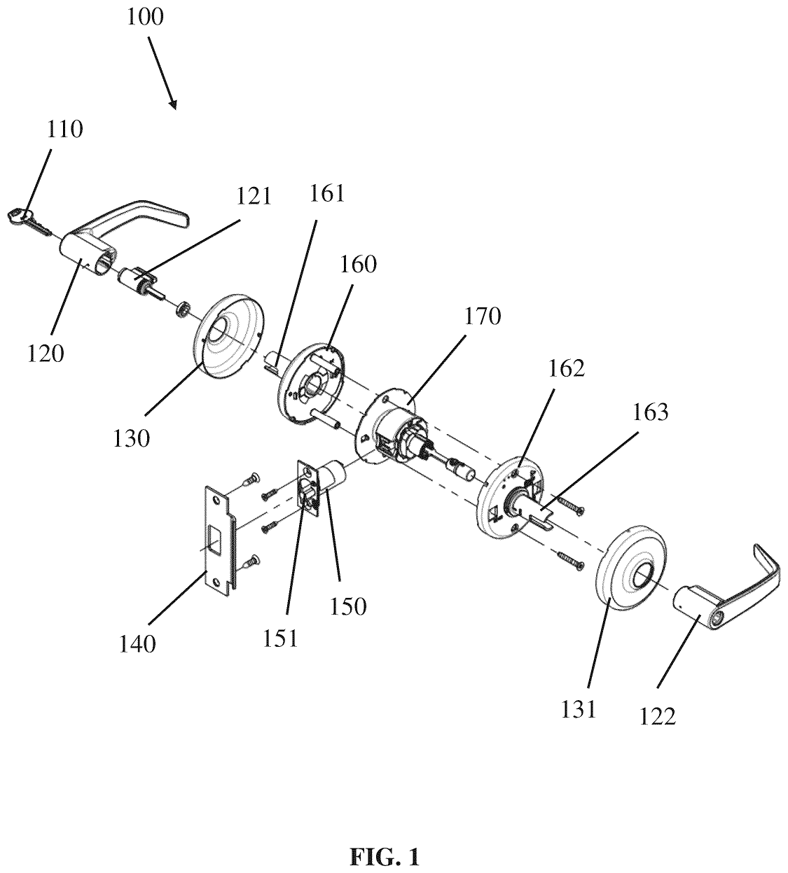

FIG. 1 is a perspective exploded view of a door lock assembly 100. The door lock assembly 100 may include a first door handle 120, a first spring housing 160, a first shank 161, and a cylinder 121 which may be received within the first shank 161. The shank 161 may in turn be coupled to a lock body 170 which may be received within a bore (e.g., a face bore) of a door. On the opposite side of the lock body 170, the assembly may include a second door handle 122, a second spring housing 162, and a second shank 163 which may be operatively coupled to the second door handle 122. The second shank 163 may in turn be coupled to the lock body 170. The first housing 160 and the second housing 162 may include a first cover 130 and a second cover 131, respectively, to conceal the spring housings when installed in a corresponding door. The lock body 170 may be coupled to a latch body 150 including a latch bolt 151, and actuation of the lock body 170 may extend and retract the latch bolt 151 through a door strike 140 to lock and unlock the door lock assembly, respectively. The latch body 150 may be received through an edge bore of a corresponding door and the door strike 140 may be mounted in the door frame and aligned to receive the latch bolt 151.

In the embodiment of FIG. 1, the door lock assembly 100 may additionally or alternatively be configured as an electronic lock system as disclosed herein. That is, the door lock assembly may include a power source configured to supply electrical energy (e.g., to a motor) to unlock and lock the lock body 170. In some embodiments, the door lock assembly may include both an electronic lock system and a mechanical key override. That is, the door lock assembly could include both an electronic credential reader (e.g., RFID, biometric sensing, electronic keypad, etc.) and the mechanical key override which may each be used to unlock and lock the lock body 170 as needed. A key 110 is shown to engage the door handle 120 to unlock and lock the lock body 170 by actuating the cylinder 121 in FIG. 1. As discussed herein, the electronic lock system may have a variety of functionalities including, but not limited to locking and unlocking the lock body, monitoring the status of the lock and/or the associated door, provided illumination, providing an indication as to the status of the lock and/or door, and transmitting and receiving signals between the lock and a gateway, or for any other suitable function as the disclosure is not so limited.

In some embodiments, the energy harvesting device (not shown in FIG. 1) according to embodiments disclosed herein may be integrated between the first housing 160 and the second housing 162 such that mechanical energy from the actuation of the door handle 120, 122 may be converted to electrical energy which is stored in an energy storage element for powering subsequent actuation of the door lock assembly. In some embodiments, the converted electrical energy may be used to directly recharge the power source (e.g., rechargeable batteries, capacitor) used in the door lock assembly to extend the operational life span of the door lock assembly.

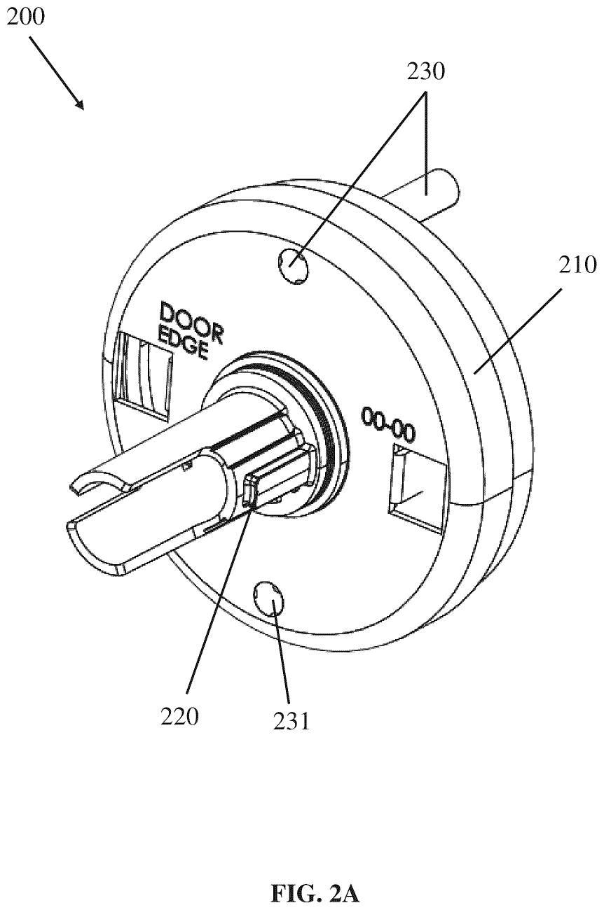

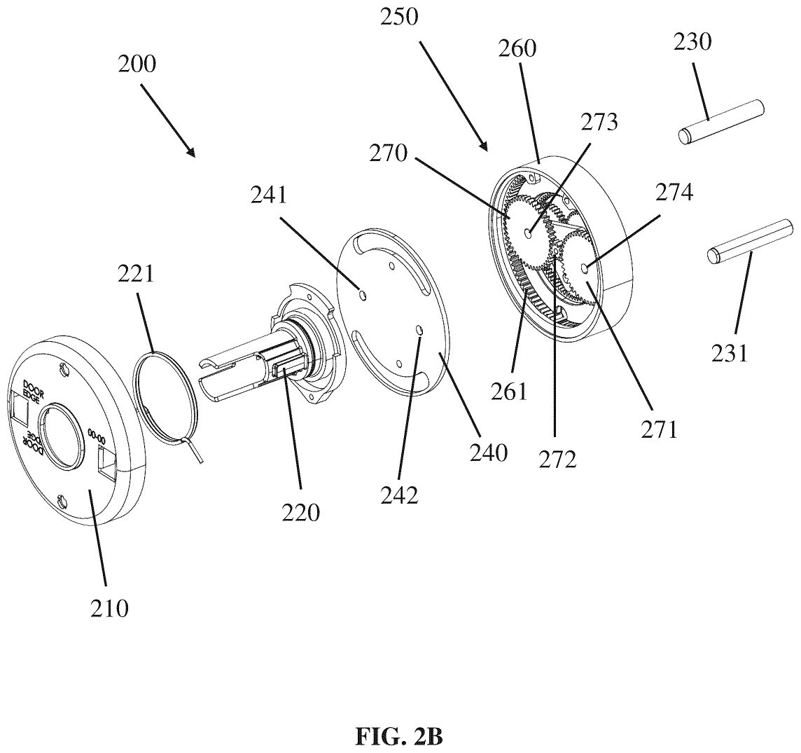

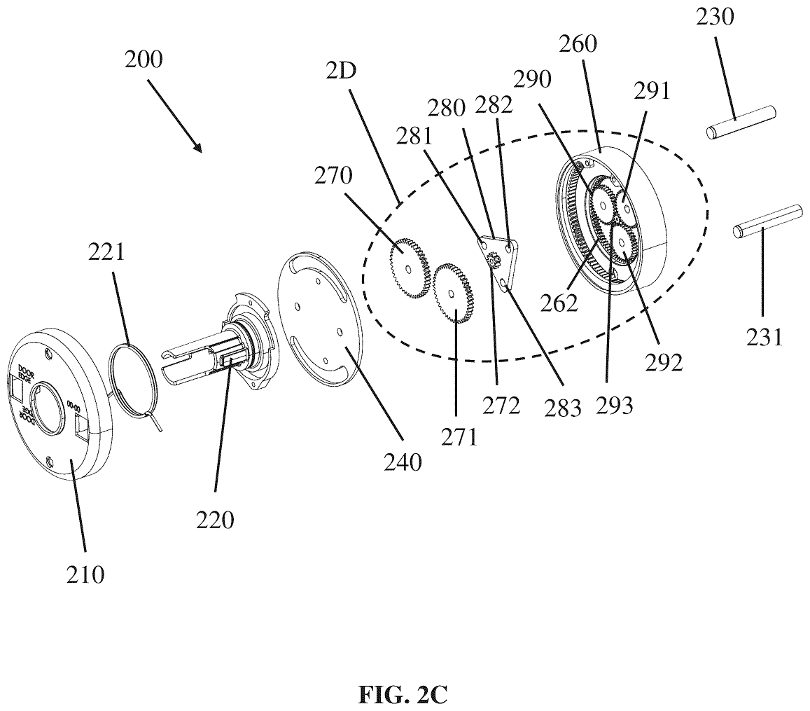

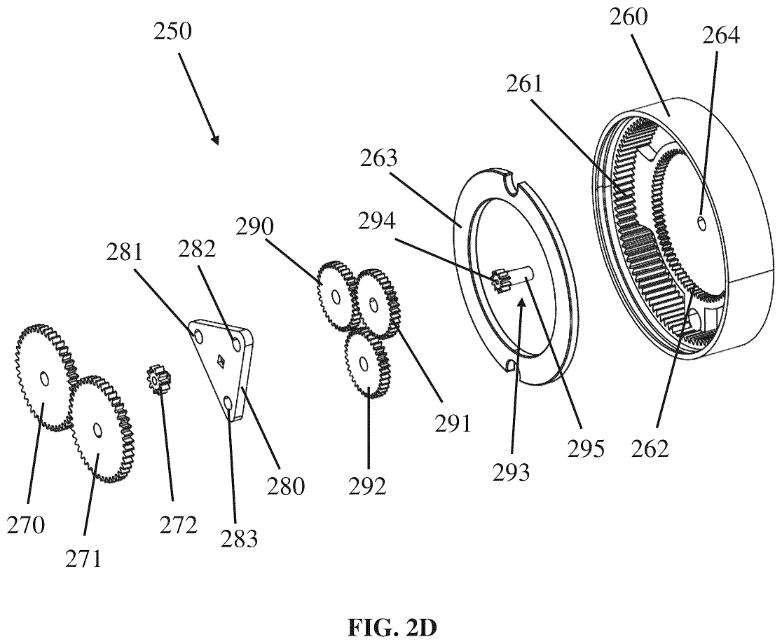

FIG. 2A is a perspective view of gearbox assembly 200 configured for use with a door lock assembly. The gearbox assembly 200 may include a housing 210, a shank 220, and one or more bolts 230, 231. The shank 220 may be configured to receive a lever of the door lock assembly which is engaged with a door handle, and actuation of the door handle may be configured to actuate the shank 220. The bolts 230 may be used to couple and secure the housing 210 to a corresponding door.

FIG. 2B is a perspective exploded view of the gearbox assembly 200 of FIG. 2A. The assembly may include a lever spring 221 configured to bias a lever (not shown) received by the shank 220 to its original position (i.e., the spring 221 may bias the lever to return to a state where it is not actuated by the door handle). The gearbox assembly 200 additionally includes a first carrier plate 240 and a gear train 250 including a first set of planetary gears 270, 271, a first sun gear 272, and a ring gear 260. The shank 220 may be secured to the first carrier plate 240 such that movement of the shank 220 via the lever moves the first carrier plate 240. The first carrier plate 240 may also be engaged with the first set of planetary gears 270, 271 such that movement of the first carrier plate 240 actuates the gear train 250. For example, suitable fasteners may be used to couple the first carrier plate 240 via holes 241, 242 to each of the planetary gears 270, 271 via their respective holes 273, 274. The ring gear 260 includes a first set of gear teeth 261 configured to engage with each of the first planetary gear 270 and the second planetary gear 271. That is, upon actuation of the first carrier plate 240, the first set of planetary gears 270, 271 may rotate along the interior of the ring gear 260 via gear teeth 261, thereby rotating the sun gear 272 engaged to the planetary gears.

As shown in the assembled view in FIG. 2A and the exploded view in FIG. 2B, in some embodiments, the through bolts 230, 231 may couple each of the gear train 250, the first carrier plate 240, the shank 220, and the first housing 210 to one another. In addition, the inventors have found that coupling the first carrier plate 240 to the first set of planetary gears 270, 271 may enable the maximum rotation angle of the planetary gears relative to the ring gear 260 to be controlled. For example, the planetary gears may be limited to rotate 45 degrees along the interior of the ring gear, though other suitable degrees of rotation are contemplated. While only two planetary gears in the first set of planetary gears are shown in the embodiment of FIG. 2B, any suitable number of planetary gears may be used as the disclosure is not so limited.

FIG. 2C is a perspective exploded view of the gearbox assembly of FIG. 2A, where the gear train 250 is shown in greater detail than in FIG. 2B. As shown in FIG. 2C, the first sun gear 272 may be coupled to a second carrier plate 280 such that rotation of the first set of planetary gears 270, 271 rotates the first sun gear 272 and in turn rotates the second carrier plate 280. The second carrier plate 280 includes a first hole 281, a second hole 282, and a third hole 283. Each of these holes (281, 282, 283) in the second carrier plate 280 are configured to mounted to a corresponding hole of the first planetary gear 290, second planetary gear 291, and third planetary gear 292 of a second set of planetary gears such that rotation of the second carrier plate 280 rotates the second set of planetary gears. The ring gear 260 may include a second set of gear teeth 262 configured to engage with each of the first, second, and third planetary gears (290, 291, 292) of the second set of planetary gears. That is, upon actuation of the second carrier plate 280, the second set of planetary gears may rotate along the interior of the ring gear 260 via the gear teeth 262, thereby rotating a second sun gear 293. The inventors have found benefits associated with providing three planetary gears (290, 291, 292) in the second set of planetary gears as such an arrangement will provide additional stability and balance to the gearbox during actuation. While three planetary gears in the second set of planetary gears are shown in the embodiment of FIG. 2C, any suitable number of planetary gears may be used as the disclosure is not so limited.

In addition, while two sets of planetary gears and two sets of sun gears are shown in the embodiments of FIGS. 2A-2D, any suitable number of gear sets may be used in the gearbox assembly as the disclosure is not so limited. Likewise, while only two carrier plates are shown in FIGS. 2A-2D, any suitable number of carrier plates may be employed to couple the planetary and sun gears to one another. Moreover, any suitable number of ring gears and sets of gear teeth in the ring gear may be provided as needed to accommodate the planetary and sun gears. For example, two ring gears each having one set of gear teeth may be provided, and each of the ring gears may receive a single set of one or more planetary gears and a single set of one or more sun gears.

FIG. 2D is a perspective exploded view of region 2D in FIG. 2C, where the gear train 250 is shown in greater detail than in FIG. 2C. As shown in FIG. 2D, the second sun gear 293 has a gear portion 294 and a shaft portion 295. The gear portion may be configured to engage with each of the planetary gears (290, 291, 292) of the second set of planetary gears. The shaft portion 295 of the second sun gear 293 may be positioned through an output opening 264 in the ring gear 260. In some embodiments, the shaft portion 295 may be coupled to a corresponding generator (e.g., a motor) as disclosed herein for converting the mechanical energy of the door lock actuation and gear train to electrical energy. In some embodiments, a mount may be positioned adjacent the output opening 264 of the ring gear 260 to hold the generator and maintain the generator in engagement with the second sun gear 293. In some embodiments, the generator may be aligned in parallel with a longitudinal axis of the output opening 264. In other embodiments, however, the generator may be transversely aligned with the longitudinal axis of the opening 264, which may serve to maintain the gearbox assembly in a more compact configuration. In some embodiments, the gearbox assembly may include one or more retaining rings or spacers 263 configured to hold the gearing components together in a compact design. While only one spacer 263 is shown in FIG. 2D, there may be a plurality of spacers that are used in the gearbox assembly, e.g., there may be a second spacer positioned within the housing 210 and in front of the first carrier plate 240.

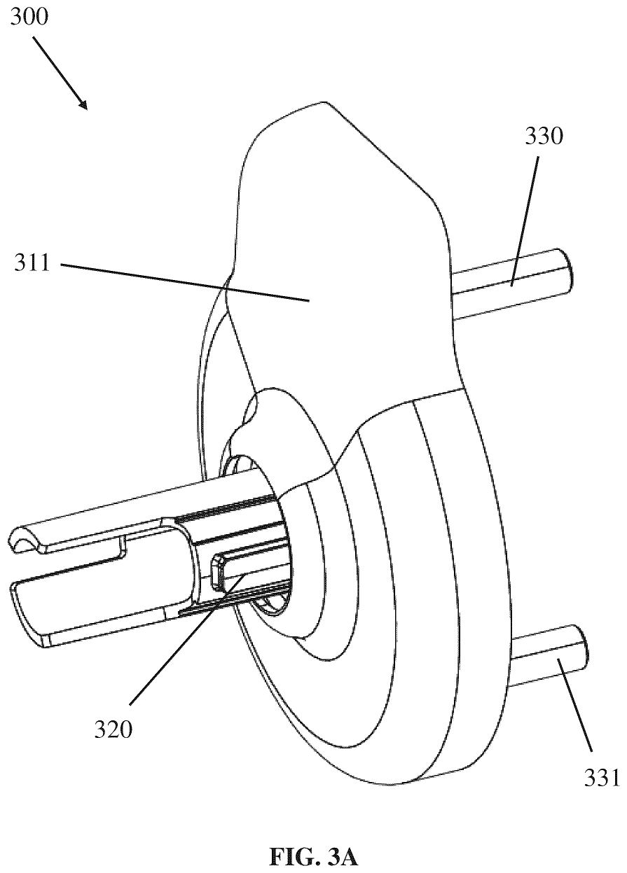

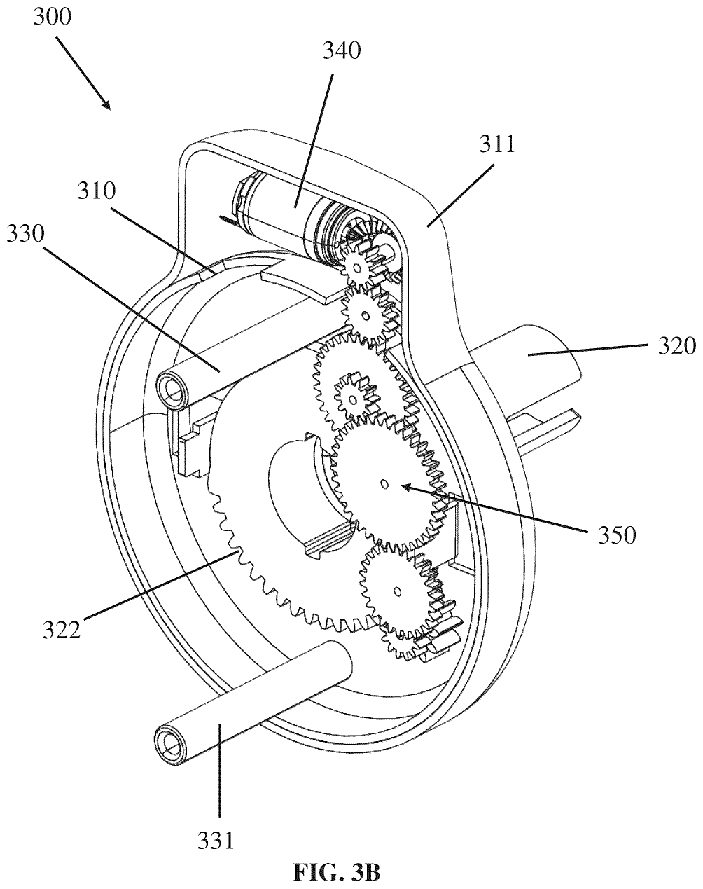

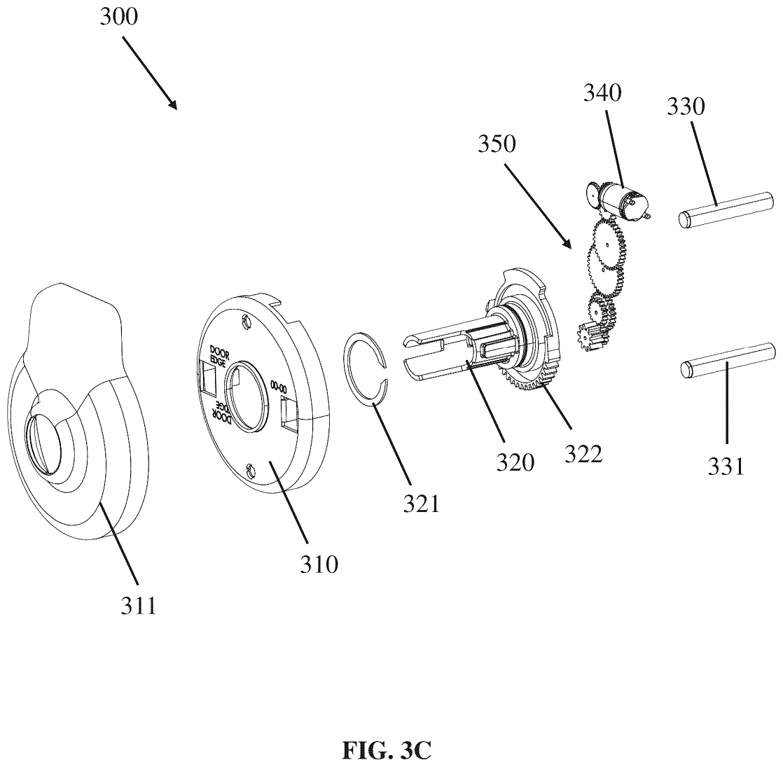

While the embodiments of FIGS. 2A-2D showed a gearbox assembly which uses planetary gearing and sun gearing to increase the rate of mechanical energy conversion, the embodiments of FIGS. 3A-3C show an arrangement where a compound spur gear train is used to increase the rate of mechanical energy conversion. FIG. 3A is a front perspective view of a gearbox assembly 300 which includes a housing 310 (shown in FIG. 3B), a cover 311 configured to conceal the housing 310, a shank 320 coupled to the housing, and bolts 330, 331 configured to secure the gearbox assembly to a corresponding door. As disclosed herein, the shank 320 may be configured to receive a lever of the door lock assembly which is engaged with a door handle, and actuation of the door handle may be configured to actuate the shank.

FIG. 3B is a rear perspective view of the gearbox assembly shown in FIG. 3A. As shown in FIG. 3B, the cover 311 conceals a housing 310. The end of the shank 320 also includes gear teeth 322 which are configured to engage to at least one gear of a compound spur gear train 350. That is, actuation of the shank 320 may actuate the compound spur gear train 350 via engagement with gear teeth 322. The number of gears, the type of gears, the number of gear teeth, and/or the configuration of the gears provided in the compound spur gear train may be of any suitable arrangement as necessary to achieve a desired gear ratio and to in turn provide a desired amount of increase in energy conversion to a generator 340 as the disclosure is not so limited. For example, the gear train 350 may include one or more bevel gears to engage the generator 340 in a transverse fashion that the generator is oriented in a direction perpendicular to a longitudinal axis of the gearbox assembly as shown in FIG. 3B. Such a configuration may allow for the gearbox assembly to achieve a more compact design. As disclosed herein, the mechanical energy provided from the actuation of the door lock assembly and gear train 350 may be converted to electrical energy via the generator 340, and the generator 340 may transfer the electrical energy to an energy storage device (not shown).

FIG. 3C is a perspective exploded view of the gearbox assembly of FIG. 3A. As shown in FIG. 3C, the gearbox assembly 300 may further include a spacer 321 which may be positioned around the shank 320 to provide spacing between the shank 320 and housing 310. Additionally, while the shank 320 is shown in FIG. 3C to only include gear teeth around a portion of the circumference of the base of the shank, in some embodiments the gear teeth may be provided around the entirety of the circumference of the base of the shank as the disclosure is not so limited.

The embodiments described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the use of energy harvesting devices for electronic bored lock systems are primarily described herein, the embodiments of an energy harvesting device may be applied to any suitable lock mechanism as the disclosure is not so limited.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An energy harvesting device for a door lock assembly, the energy harvesting device comprising:
a gear train comprising a plurality of gears operatively coupled to one another, wherein the gear train is operatively coupled to a door handle of the door lock assembly such that an actuation of the door handle actuates the plurality of gears, and wherein a gear ratio of the gear train is greater than or equal to 30:1;
a generator operatively coupled to the gear train, wherein the generator is configured to convert mechanical energy provided from the gear train when the plurality of gears are actuated to electrical energy; and
an energy storage device configured to store the electrical energy converted by the generator.

2. The energy harvesting device of claim 1, wherein the gear train is a planetary gear train, and wherein the plurality of gears include one or more planetary gears and one or more sun gears.

3. The energy harvesting device of claim 2, wherein the planetary gear train further includes a ring gear, wherein the ring gear is configured to receive and engage with at least one of the one or more planetary gears.

4. The energy harvesting device of claim 3, wherein the one or more planetary gears includes a first set of planetary gears and a second set of planetary gears.

5. The energy harvesting device of claim 4, wherein the first set of planetary gears includes two planetary gears and the second set of planetary gears includes three planetary gears.

6. The energy harvesting device of claim 4, wherein the one or more sun gears includes a first sun gear and a second sun gear, wherein the first sun gear is configured to engage with the first set of planetary gears and the second sun gear is configured to engage with the second set of planetary gears.

7. The energy harvesting device of claim 4, wherein the ring gear includes a first set of gear teeth and a second set of gear teeth, wherein the first set of gear teeth are configured to engage with the first set of planetary gears, and wherein the second set of gear teeth are configured to engage with the second set of planetary gears.

8. The energy harvesting device of claim 1, in combination with the door lock assembly, wherein the door lock assembly further comprises a lever operatively coupled to the door handle and a shank which receives the lever, and wherein the shank is operatively coupled to the gear train.

9. The energy harvesting device of claim 8, wherein the plurality of gears includes first and second sets of planetary gears and one or more sun gears, and further comprising a first carrier plate coupled to the shank, wherein the first carrier plate is coupled to the first set of planetary gears, and further comprising a second carrier plate, wherein the second carrier plate is coupled to at least one of a first sun gear of the one or more sun gears and the second set of planetary gears.

10-11. (canceled)

12. The energy harvesting device of claim 1, in combination with the door lock assembly, wherein the door lock assembly further comprises a shank including a plurality of gear teeth, wherein the shank is engaged to at least one of the plurality of gears via the plurality of gear teeth, and wherein the shank is operatively coupled to a door handle of the door lock assembly such that actuation of the door handle actuates the gear train.

13-15. (canceled)

16. The energy harvesting device of claim 1, further comprising a controller, wherein the controller is configured to control the actuation of the door lock using the electrical energy stored in the energy storage device.

17. (canceled)

18. An energy harvesting device for a door lock, the energy harvesting device comprising:
a gear train comprising a plurality of gears operatively coupled to one another, wherein the gear train is operatively coupled to a door handle such that an actuation of the door handle actuates the plurality of gears, wherein the gear train is a planetary gear train and the plurality of gears include one or more planetary gears and one or more sun gears;
a generator operatively coupled to the gear train, wherein the generator is configured to convert mechanical energy provided from the gear train when the plurality of gears are actuated to electrical energy; and
an energy storage device configured to store the electrical energy converted by the generator.

19. The energy harvesting device of claim 18, wherein the planetary gear train further includes a ring gear, wherein the ring gear is configured to receive and engage with at least one of the one or more planetary gears, wherein the one or more planetary gears includes a first set of planetary gears and a second set of planetary gears.

20. (canceled)

21. The energy harvesting device of claim 19, wherein the first set of planetary gears includes two planetary gears and the second set of planetary gears includes three planetary gears.

22. The energy harvesting device of claim 19, wherein the one or more sun gears includes a first sun gear and a second sun gear, wherein the first sun gear is configured to engage with the first set of planetary gears and the second sun gear is configured to engage with the second set of planetary gears.

23. The energy harvesting device of claim 19, wherein the ring gear includes a first set of gear teeth and a second set of gear teeth, wherein the first set of gear teeth are configured to engage with the first set of planetary gears, and wherein the second set of gear teeth are configured to engage with the second set of planetary gears.

24. The energy harvesting device of claim 18, in combination with the door lock assembly, wherein the door lock assembly further comprises a lever operatively coupled to the door handle and a shank which receives the lever, and wherein the shank is operatively coupled to the gear train.

25. The energy harvesting device of claim 24, wherein the one or more planetary gears comprises first and second sets of planetary gears, and further comprising a first carrier plate coupled to the shank, wherein the first carrier plate is coupled to the first set of planetary gears, and further comprising a second carrier plate, wherein the second carrier plate is coupled to at least one of a first sun gear of the one or more sun gears and the second set of planetary gears.

26-27. (canceled)

28. The energy harvesting device of claim 18, in combination with the door lock assembly, wherein the door lock assembly further comprises a shank including a plurality of gear teeth, wherein the shank is engaged to at least one of the plurality of gears via the plurality of gear teeth, and wherein the shank is operatively coupled to a door handle of the door lock assembly such that actuation of the door handle actuates the gear train.

29-31. (canceled)

32. The energy harvesting device of claim 18, further comprising a controller, wherein the controller is configured to control the actuation of the door lock using the electrical energy stored in the energy storage device.

33. (canceled)
